(19) United States
(12) Patent Application Publication
(10) Pub. No.: US 2014/0018167 A1
(43) Pub. Date: Jan. 16, 2014

(54) USER MANIPULATION OF VORONOI DIAGRAM GAME MECHANICS

(71) Applicant: Ales Golli, Ljubljana (SI)

(72) Inventor: Ales Golli, Ljubljana (SI)

(21) Appl. No.: 13/939,155

(22) Filed: Jul. 10, 2013

Related U.S. Application Data
(60) Provisional application No. 61/670,387, filed on Jul. 11, 2012.

(51) Int. Cl. A63F 13/00

(52) U.S. Cl. CPC A63F 13/00
USPC 463/31

(57) ABSTRACT

System, method and apparatus for executing video games. In one particular embodiment of a game, which has spatial geometry based on the Voronoi Diagram, a user may be allowed to interactively move Voronoi Sites, or generating points, for the Voronoi Diagram and thus modify the Voronoi Cells and the game's geometry. In this way, the user may achieve sub-goals and goals in various games or other applications of entertaining, educational or other nature. Thus the user is provided, within a context of an unusual and interesting unorthogonal geometry, with a novel principle of operation which provides a new, unique and entertaining experience.

### CROSS-REFERENCE TO RELATED APPLICATION

The present application claims the priority benefit of U.S. Provisional Patent Application Ser. No. 61/670,387, filed Jul. 11, 2012, which is incorporated herein by reference in its entirety.

### BACKGROUND OF THE INVENTION

1. Field of the Invention

The present invention relates generally to user manipulation of Voronoi Diagram based user interface elements and, more particulary, to user manipulation of Voronoi Diagram game mechanics.

2. Description of the Related Art

Many video games have a game mechanics, in which a user manipulates, moves or modifies game elements. These elements have distinctive properties, such as colors, patterns, or symbols written on them. Such games have a variety of types. The elements may take the shape of a square, rectangle, cube, circle, bubble, or block. The user may be required to move and group the game elements in order to form a meaningful cluster of elements; for example, a cluster of elements of the same color or a cluster of elements comprising a word, where each of the elements bears a letter of the word. Forming a meaningful cluster may represent a sub-goal of the game. After the cluster is formed, the element comprising the cluster may be removed from the game. The removal of all the elements from the game may be the goal of one type of such a game.

Voronoi Diagrams have been used in computer graphics in various embodiments, most often for spatial analysis, but rarely in video games.

Voronoi Diagrams have been used in video games, but not in such a manner that the Voronoi Diagram represents a crucial element of the game, as the visible geometry of the game space. For example, U.S. Pat. No. 7,588,493 B2, issued to Rupert, et al. on Sep. 15, 2009, discloses Voronoi Diagrams being used to analyze the game situation. Unlike the present invention, the Voronoi Diagrams are neither a crucial nor a visible element of the game, which the user can actively and intentionally manipulate.

Others have used Voronoi diagrams in video games, but not in such a manner that the user actively manipulates the geometry of game space by moving existing Voronoi Sites—generating points that are the basis for the calculation of the Voronoi Diagram—and thus actively manipulating the geometry of the game space, which is based on the Voronoi Diagram. For example, in the “Voronoi game”, described by Shasha in 1992 (implemented by Poultney and Faidley in 1996 at http://www.voronoigame.com; analyzed by Ahn in 2001), users place the Voronoi Sites, but they cannot move them around and thus cannot actively and intentionally modify the visible geometry of the game space during the game.

### ADVANTAGES

Thus, there are several advantages of one or more aspects provided for the user. The user of the game is provided with unusual and interesting unorthogonal game geometry, based on the Voronoi Diagram. Other advantages of one or more aspects are that the user can actively and intentionally manipulate and modify the visible geometry of the game space, which provides a new, unique and entertaining experience. These and other advantages of one or more aspects will become apparent from a consideration of the ensuing description and accompanying drawings.

The Applicant is unaware of inventions or patents, taken either singly or in combination, which are seen to describe the present invention as claimed.

### SUMMARY OF THE INVENTION

The present invention is directed to a novel method for playing video games, where the user actively manipulates the game's geometry using the Voronoi Diagram. Additionally, the method for user manipulation of Voronoi Diagram based user interface elements may be used in various applications, such as, but not limited to, entertaining games, educational games, educational applications, photo-related applications, and other applications.

In one embodiment, the observed space is decomposed using the Voronoi Diagram, generated from the initial set of Voronoi Sites (generating points) at random positions and comprising of Voronoi Cells with specific properties. In this embodiment, the distinctive property of a Voronoi Cell is color.

In this embodiment, the Voronoi Diagram is calculated using Fortune's algorithm, which is well known to those skilled in software art, but other existing methods for calculating the Voronoi Diagrams can also be used.

In this embodiment, the user is allowed to move any Voronoi Cell by moving a position of an existing Voronoi Site (and thus the Voronoi Cell) with a method of interacting with the mobile device or computer (e.g., dragging with a mouse or panning using a touch screen). As the user moves the user-controlled Voronoi Cell, the entire Voronoi Diagram is recalculated and redrawn. Voronoi Cells currently adjacent to user-controlled Voronoi Cell adapt their shape according to the computation of the Voronoi Diagram.

In this embodiment, the sub-goal of the game is to remove clusters of (4 or more, in this embodiment) Voronoi Cells by rearranging the Voronoi Cells of the Voronoi Diagram (e.g., grouping a set of Voronoi Cells of same property, such as color, into clusters in order to remove them from the gaming board).

In this embodiment, the final goal of the game is to remove all the Voronoi Cells within a limited number of moves or a limited amount of time.

Another embodiment provides a computer readable storage medium comprising a program product, which, when executed, is configured to perform an operation to execute a video game. The operation may include the generation of an initial set of Voronoi Sites, the calculation and the display of the Voronoi Diagram. In this embodiment the user may utilize the game's user interface to move a Voronoi Site and may thus actively modify the game's geometry, which may be needed to achieve sub-goals and goals of the game.

### BRIEF DESCRIPTION OF THE DRAWINGS

FIGS. 1A to 1D show the movement of a user-controlled Voronoi Cell according to the present invention, while currently adjacent Voronoi Cells adapt their shape according to the computation of the Voronoi Diagram;

FIGS. 2A to 2D show the movement of the user-controlled Voronoi Cell until the user-controlled Voronoi Cell becomes adjacent to at least one Voronoi Cell of the cluster of the same-property Voronoi Cells;

FIG. 3 shows a user's interaction with an embodiment of a system according to the present invention;

FIG. 4 shows a flowchart of an embodiment of a method for playing a video game according to the present invention;

FIGS. 5A to 5D show one embodiment, where a path of special interest follows the edges of the Voronoi Cells. As the user moves the Voronoi Site of a Voronoi Cell, the Voronoi Diagram is recalculated and redrawn. The path is changed accordingly, and follows the new arrangement of the Voronoi Cells and their edges; and

FIG. 6 shows a flowchart of another embodiment of the method for user manipulation of Voronoi Diagram based user interface elements according to the present invention.

It should be understood that the above-attached figures are not intended to limit the scope of the present invention in any way.

### DETAILED DESCRIPTION OF THE PREFERRED EMBODIMENTS

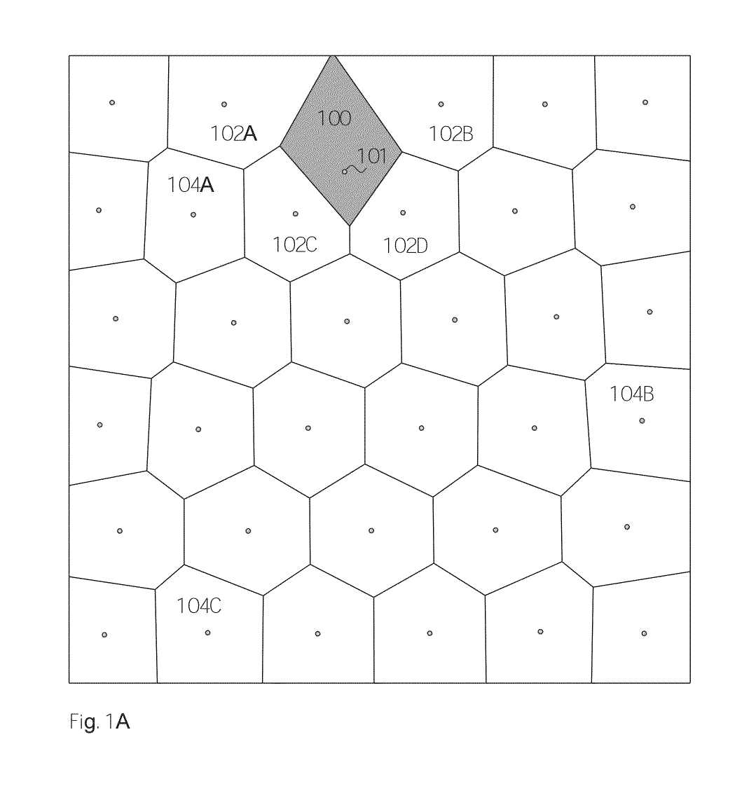

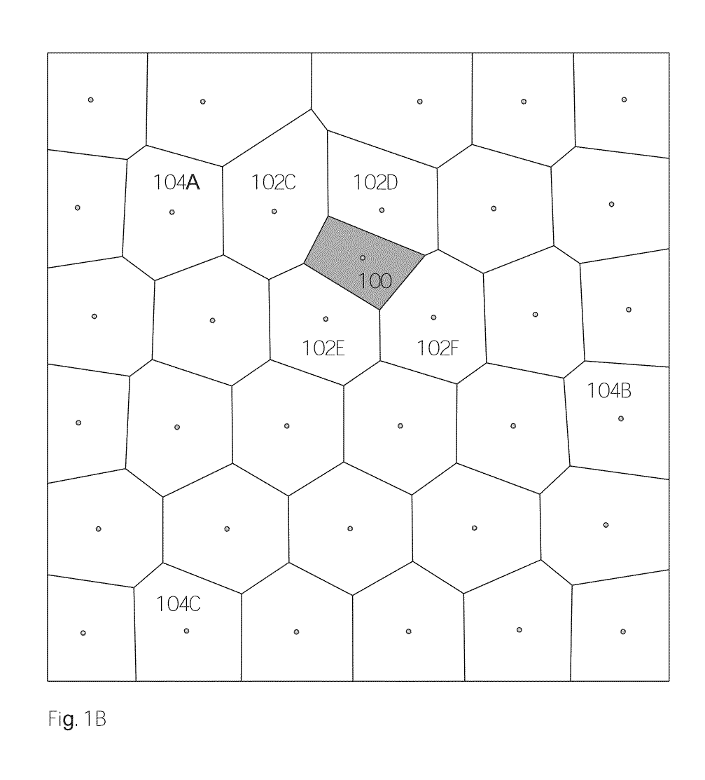

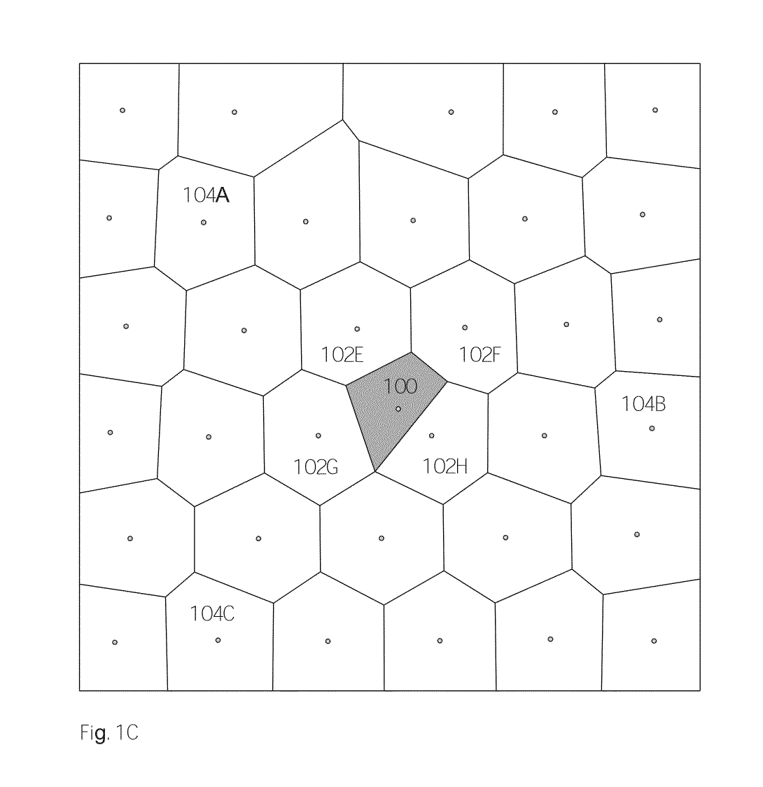

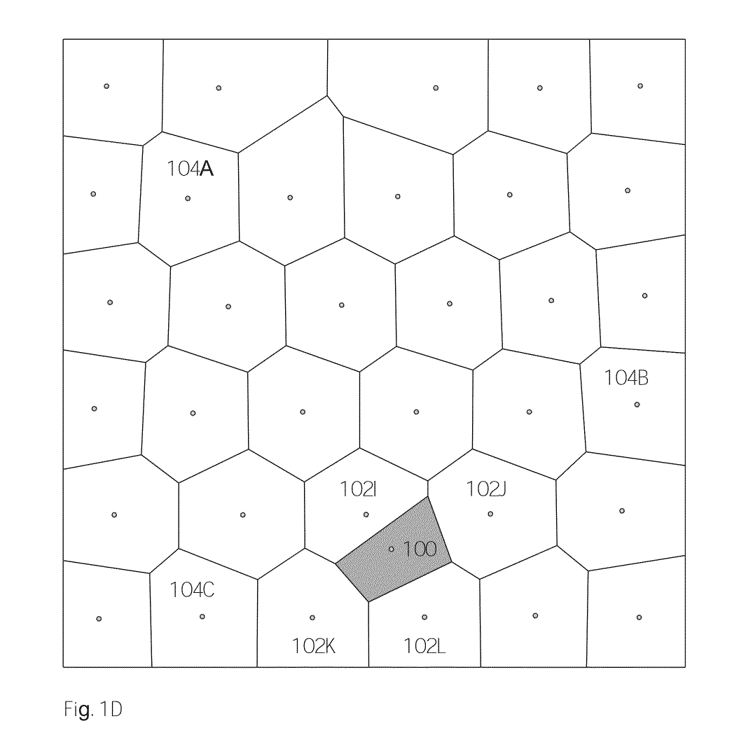

A first embodiment of the present invention is illustrated in FIGS. 1A to 1D, FIGS. 2A to 2D, FIG. 3 and FIG. 4.

At the present, the Applicant believes that this embodiment operates most efficiently, but the other embodiments are also satisfactory. Other embodiments may be used in various applications, such as, but not limited to, entertaining games, educational games, educational applications, photo-related applications, and other applications.

FIGS. 1A to 1D depict one aspect of the first embodiment of the present invention. Observed space is decomposed using the Voronoi Diagram. In this embodiment, the Voronoi Diagram is calculated using Fortune's algorithm, which is well known to those skilled in computer art, but other existing methods for calculating the Voronoi Diagrams can also be used. A user-controlled Voronoi Cell 100 is controlled by a user. As the user moves a Voronoi Site 101 of the user-controlled Voronoi Cell 100, the Voronoi Diagram is recalculated and redrawn. FIGS. 1A to 1D show the movement of the user-controlled Voronoi Cell 100 through the observed space. As the user-controlled Voronoi Cell 100 moves, currently adjacent Voronoi Cells 102A to 102L adapt their shape, according to the computation of the Voronoi Diagram. Other Voronoi Cells, such as Voronoi Cells 104A to 104C, remain unaffected.

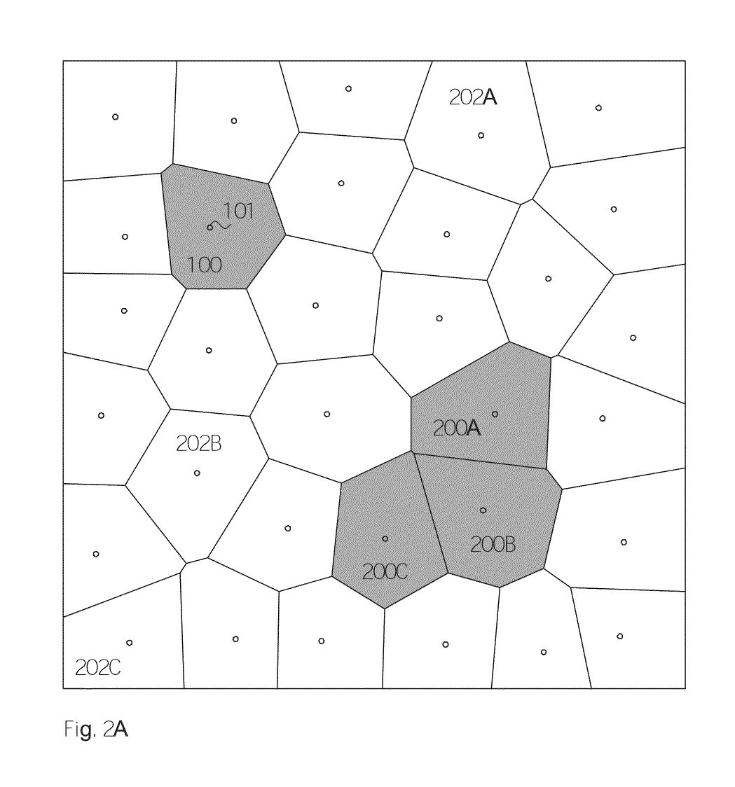

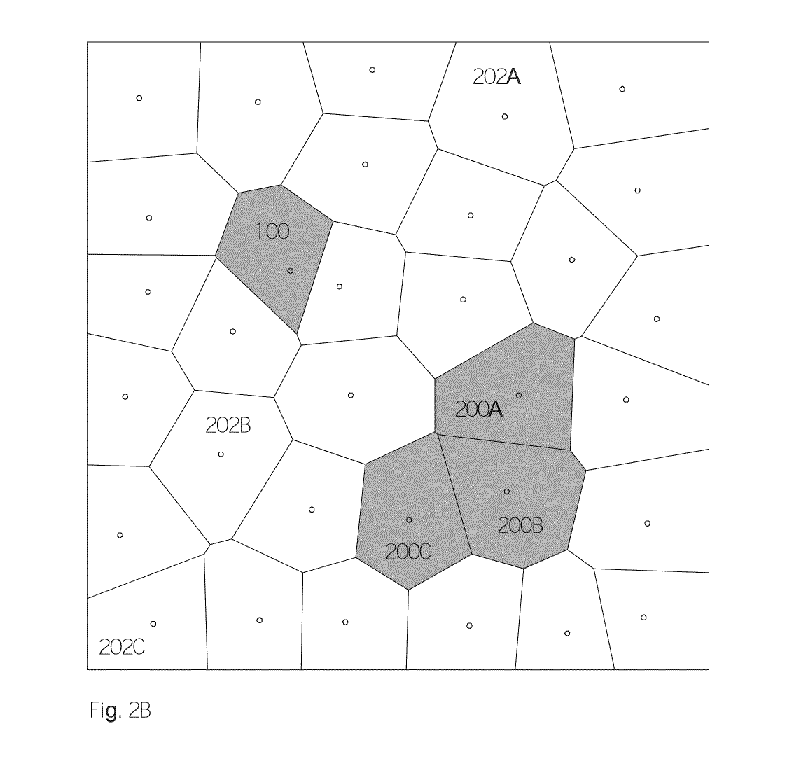

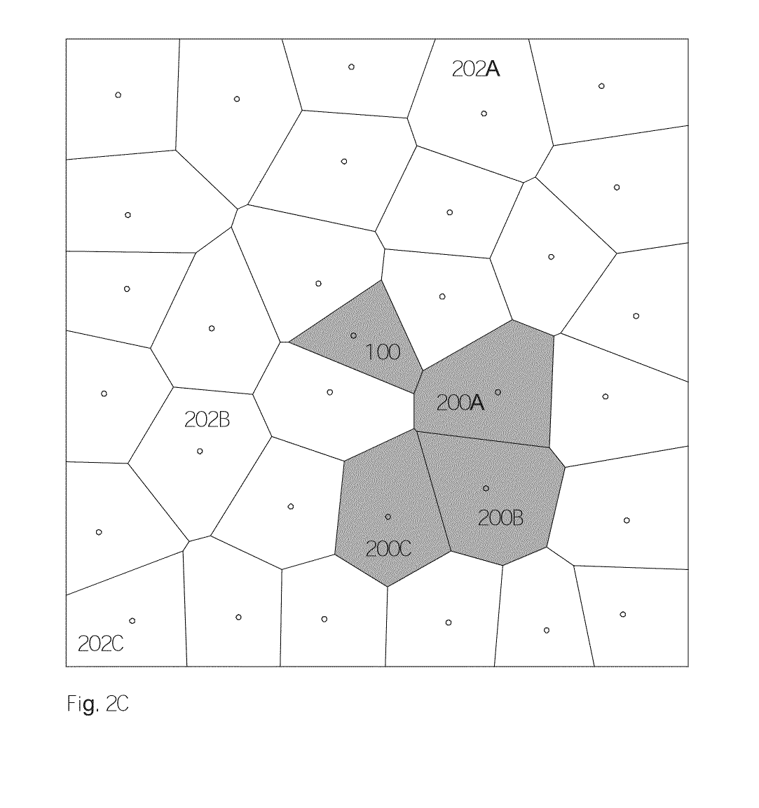

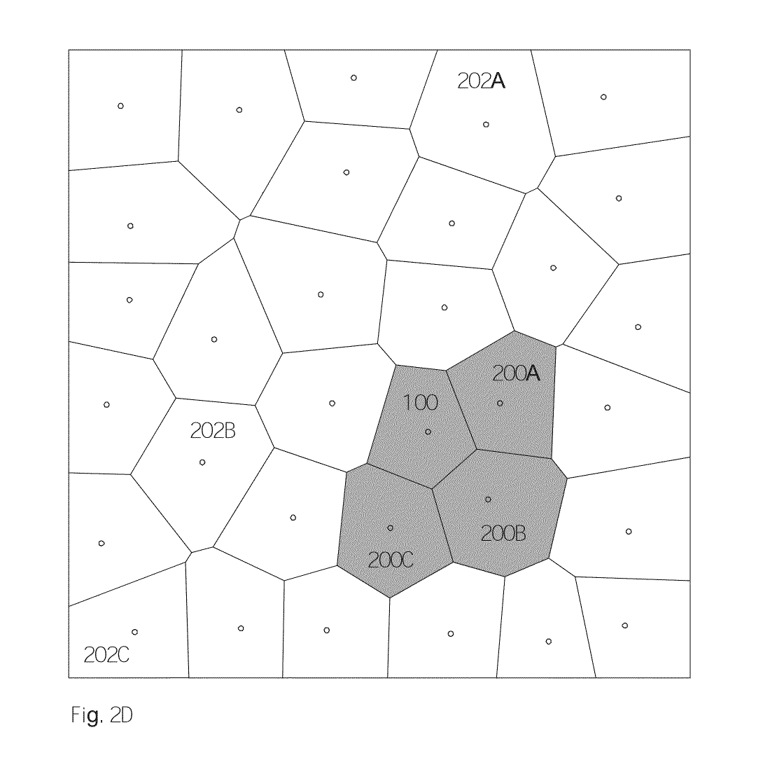

FIGS. 2A to 2D depict one aspect of the first embodiment of the present invention. Observed space is decomposed using the Voronoi Diagram. There is a user-controlled Voronoi Cell 100. The cluster of three Voronoi Cells 200A to 200C has the same significant property, such as color, pattern, number, letter, or other symbol or any other property, as the user-controller Voronoi Cell 100. Other Voronoi Cells, such as 202A to 202C, have a different significant property. The user achieves the sub-goal of the game by moving the Voronoi Site 101 of the user-controlled Voronoi Cell 100, until the user-controlled Voronoi Cell 100 becomes adjacent to at least one Voronoi Cell of the cluster of the same-property Voronoi Cells 200A to 200C.

System Hardware, Software and Components

The embodiments can be implemented using a conventional general purpose or a specialized digital computer or mobile device, with the microprocessor programmed according to the teachings of the present disclosure, as will be apparent to those skilled in the computer art.

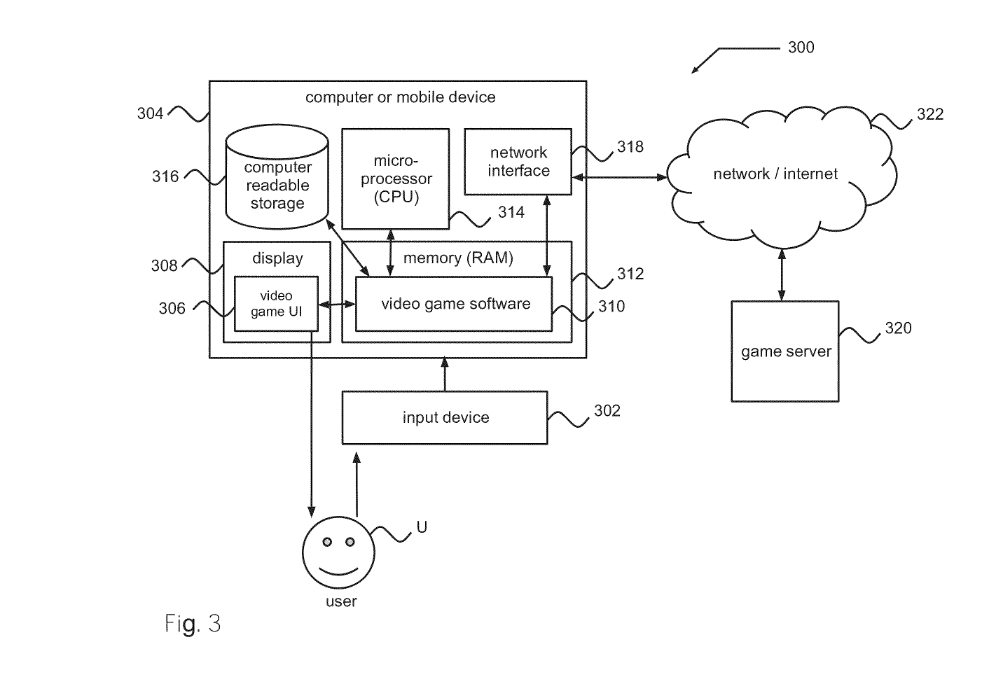

FIG. 3 depicts the user's interaction with one embodiment of the system 300. A user U uses an input device 302 of a computer or mobile device 304 and receives the feedback via a game's user-interface 306 on a computer's or mobile device's display 308. The input device 302 may be a computer mouse, a computer keyboard, a touch-screen, a motion-capture camera for recording the user's gestures, or any other device for capturing user's input. A video game software 310 resides in a computer's memory (RAM) 312 and uses the computer's or mobile device's components such as a microprocessor (CPU) 314 for performing the calculations, the display or touch-screen 308 for displaying the game's user-interface 306, a computer-readable storage 316 for storing the game state and a network interface 318 for communicating with a game server 320 via internet or other networks 322.

Operations

Appropriate software coding can readily be prepared by a skilled programmer based on the teachings of the present disclosure, as will be apparent to those skilled in the software art.

In first embodiment, the user U controls the movement of the Voronoi Site 101, of the user-controlled Voronoi Cell 100 within the game, by using an input device 302. The Voronoi Site 101, together with other Voronoi Sites of other currently adjacent Voronoi Cells 102A to 102L and unaffected Voronoi Cells, such as Voronoi Cells 104A to 104C, form the basis for the calculation of the Voronoi Diagram, which decomposes the game's space into Voronoi Cells of different specific properties, such as color.

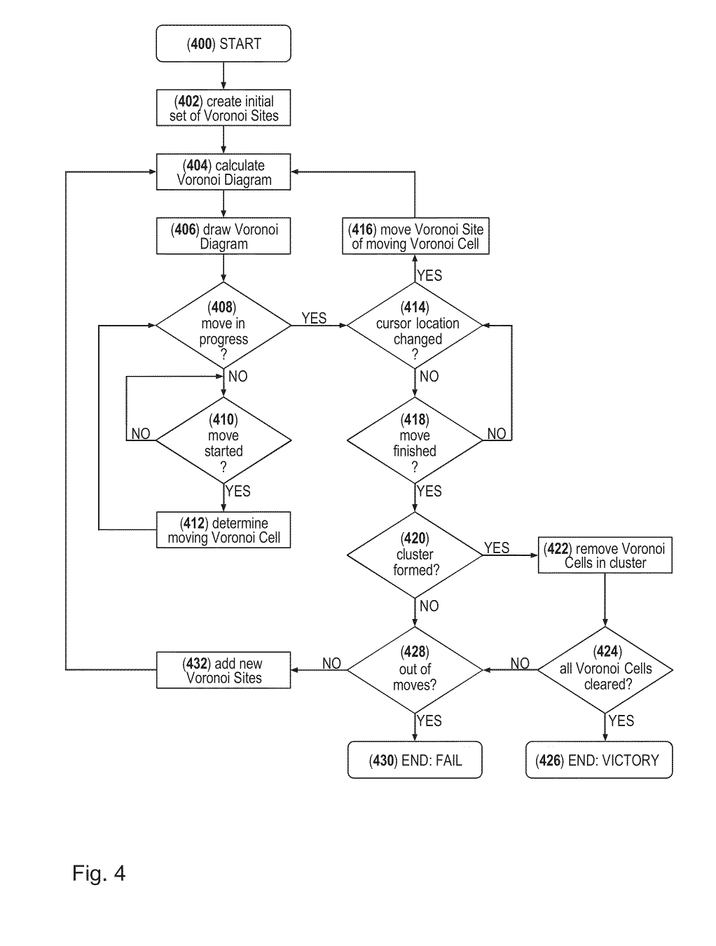

FIG. 4 is a flowchart of a first embodiment of a method for playing a video game according to the present invention. After the game is started (step 400), an initial set of Voronoi Sites is created (step 402). In this embodiment, the Voronoi Sites are positioned randomly across the screen, but other methods of initial placing of Voronoi Sites may be used. Using the initial set of Voronoi Sites, the Voronoi Diagram is calculated (step 404) and drawn (step 406).

In this embodiment, the Voronoi Diagram is calculated using Fortune's algorithm, which is well known to those skilled in computer art, but other existing methods for calculating the Voronoi Diagrams can also be used. After each move, the Voronoi Diagram is recalculated and redrawn.

If there is no move in progress (step 408), the system waits for a move to be started (step 410). After the user initiates the move using the input device 302, the moving Voronoi Cell 100 is determined (step 412) as the Voronoi Cell which contains the (x, y) point which the user points to. This is the user-controlled Voronoi Cell 100 (FIG. 1A).

When the move is in progress (step 408), the system observes if the cursor location (x, y) changes (step 414) by the user's interaction with the input device 302. If the cursor location is changed (Δx, Δy), the Voronoi Site 101 of the moving Voronoi Cell 100 is moved accordingly (Δx, Δy) (step 416), and then the Voronoi Diagram is recalculated (step 404) and redrawn (step 406). In the first embodiment, the Voronoi Cells are painted in one of six different colors.

The user achieves the sub-goal of the game by moving the Voronoi Site 101 of the user-controlled Voronoi Cell 100 until the user-controlled Voronoi Cell 100 becomes adjacent to at least one Voronoi Cell of the cluster of the same-property Voronoi Cells, such as 200A to 200C (FIGS. 2C and 2D).

When the user U finishes the move (step 418) by using the input device 302, the system analyzes the new situation and determines if the moved Voronoi Cell 100 participates in a cluster of the Voronoi Cells with the required minimal number of Voronoi Cells of the same property, such as color, pattern, etc. (step 420). If this is so, all the Voronoi Cells of the cluster are removed from the Voronoi Diagram (step 422).

After determining that the move has been finished (step 418), analyzing if a new cluster has been formed (step 420) and analyzing if the game has been successfully finished (step 424), the system checks if the user is out of moves (step 428). If the user is out of moves, the game ends with the user's failure (step 430). If the user is not out of moves, the game continues with the next step of adding new Voronoi Sites (step 432). In this embodiment, the new Voronoi Sites are positioned randomly across the screen, but other methods of placing of new Voronoi Sites may be used. After the new Voronoi Sites are added (step 432), the game continues with the recalculation (step 404) and redrawing (step 406) of the Voronoi Diagram, then the game again waits for the next move (steps 408 and 410).

The user completes the final goal of the game when the user removes all the cells from the game. If there are no more cells left (step 424), the game is successfully finished (step 426).

### ALTERNATIVE EMBODIMENTS AND RAMIFICATIONS

The present invention lends itself to many varieties of embodiments. Although the invention can be applied to various embodiments, some other embodiments are specifically mentioned by way of example.

The disclosed embodiments may be used in various applications, such as, but not limited to, entertaining games, educational games, educational applications, photo-related applications, and other applications:

### (1) First Example

Besides the user's action, there may be other sources of influence on the trajectory of the Voronoi Site, which is the basis for the calculation of the Voronoi Diagram, that is moved by the user. Other sources of influence may include various simulations of physical force, such as gravity, or other influences on the trajectory of the movement.

### (2) Second Example

Other Voronoi Cells, such as 102A to 102L and 104A to 104C (FIG. 1A), that are not currently under the control of a user, might be static (staying still) or dynamic (moving at their own pace in various directions). Movements of dynamic (or moving) Voronoi Cells are controlled by the computer (or mobile device) according to various strategies, such as random movements, simulations of movements in the physical world, rules of gravity, etc.

### (3) Third Example

New Voronoi Sites (and thus Voronoi Cells) may be added by the computer during the game. Many different rules and algorithms may govern the position of the new Voronoi Sites, for example, they may be added at random positions or they may be added at positions following various geometric functions, paths, or patterns. New Voronoi Sites may be added after the user's executed move or at timed intervals.

### (4) Fourth Example

The user may move more than one Voronoi Site, which is the basis for the calculation of the Voronoi Diagram, at the same time. The Voronoi Cells of moving Voronoi Sites may be connected into a cluster with a visual marking (e.g. thicker line, different texture, etc.).

### (5) Fifth Example

The number of different properties, such as color, assigned to the Voronoi Cells, may be six, more than six or less than six. Properties other than color may be used, for example, but not limited to: pattern, number, letter, or other symbol or any other property.

### (6) Sixth Example

The Voronoi Cells may be grouped in clusters even when having different properties, but those properties may meaningfully connect the Voronoi Cells according to rules of the game. For example, a game may give the user a sub-goal for building words consisting of letters, which may be a property of the Voronoi Cells. In this case, when the game, for example, asks for the word “HOUSE”, five Voronoi Cells (bearing letters “H”, “O”, “U”, “S” and “E”) form a cluster.

### (7) Seventh Example

The Voronoi Cells may be grouped in clusters even when having different properties, but those properties may meaningfully connect the Voronoi Cells according to rules of the game. For example, a game may give the user a sub-goal for calculating a given sum or product, of the numbers, which may be a property of the Voronoi Cells. In this case, when the game, for example, asks for the sum “18”, the Voronoi Cells bearing numbers “9”, “−3”, “7”, and “5”) may form a meaningful cluster. In another example, when the game asks for the product “30”, the Voronoi Cells bearing numbers “2”, “3”, and “5” may form a meaningful cluster.

### (8) Eighth Example

The first embodiment describes that only the cluster with a minimum number of Voronoi Cells having the same distinctive property, in which the moved Voronoi Cell takes part, is removed. An alternate embodiment may provide a way in which all the clusters with a minimum number of the Voronoi Cells having the same distinctive property are removed. After each removal, new clusters of the Voronoi Cells may be formed and observed, and new removal of such clusters may take place. In such a way, a cascading removal of clusters of Voronoi Cell of the same property may occur after one move.

### (9) Ninth Example

Additional artistic and graphic effects, such as photos, pictures, illustrations, textures, transparency and various graphic effects (such as bevel, emboss, color gradient, etc.) may be applied to the Voronoi Cells.

### (10) Tenth Example

While the first embodiment limits the duration of the game by available moves, there may be a time-limited variation of the game. In such an embodiment, the user is given a limited amount of time, in which she has to clear all the Voronoi Cells from the game space.

### (11) Eleventh Example

While the first embodiment limits the duration of the game by available moves, there may be a variation of the game, which bases the duration of the game on the number of Voronoi Cells. In such an embodiment, the game itself adds Voronoi Cells after each user's move. When the user is not successful enough in clearing the Voronoi Cells, the number of Voronoi Cells rises. When it reaches the predefined threshold, the game ends with the user's failure.

### (12) Twelfth Example

While the first embodiment describes a single-user game, there might be an embodiment with two or even more users, playing the same game competitively or collaboratively. Users may execute their moves in sequence (turn-based game) or anytime, without limits (arcade game). In such an embodiment, the data of the multi-user game is shared among users using the network/internet 322 (FIG. 3) and optionally the game server 320 (FIG. 3). Alternatively, users may share the data of the multi-user game using local connections among their devices (Wi-Fi, Bluetooth).

### (13) Thirteenth Example

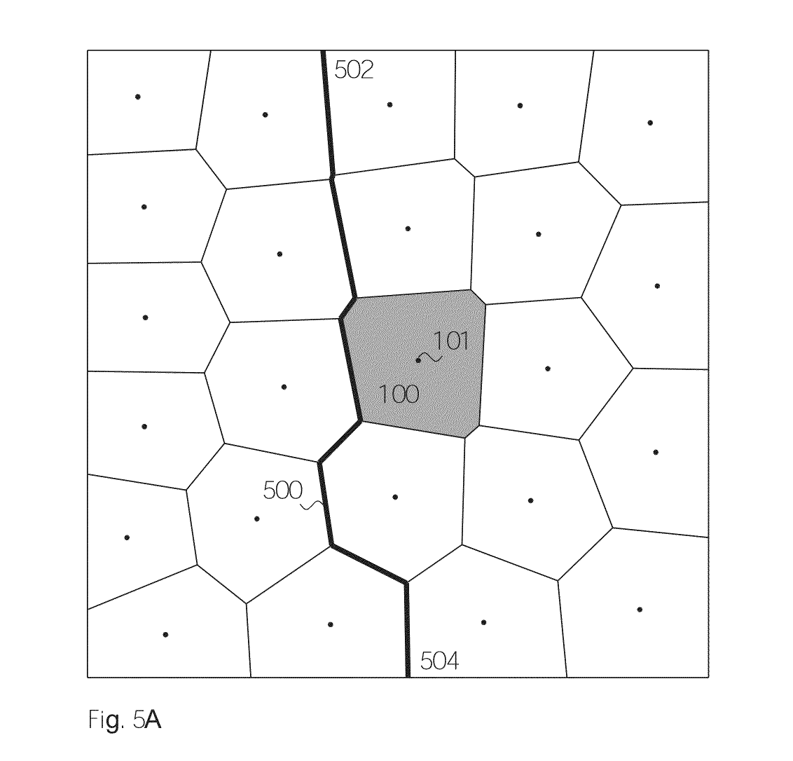

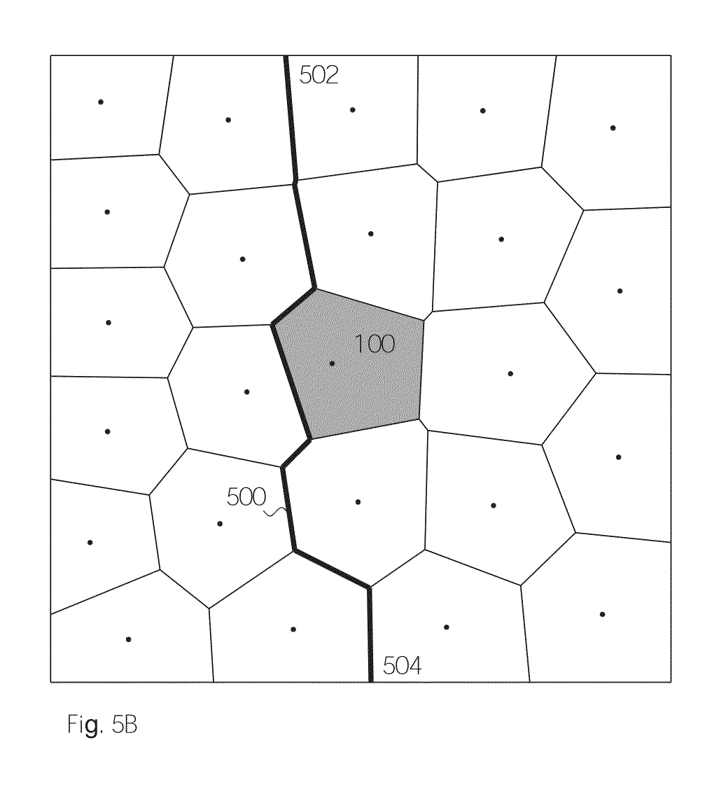

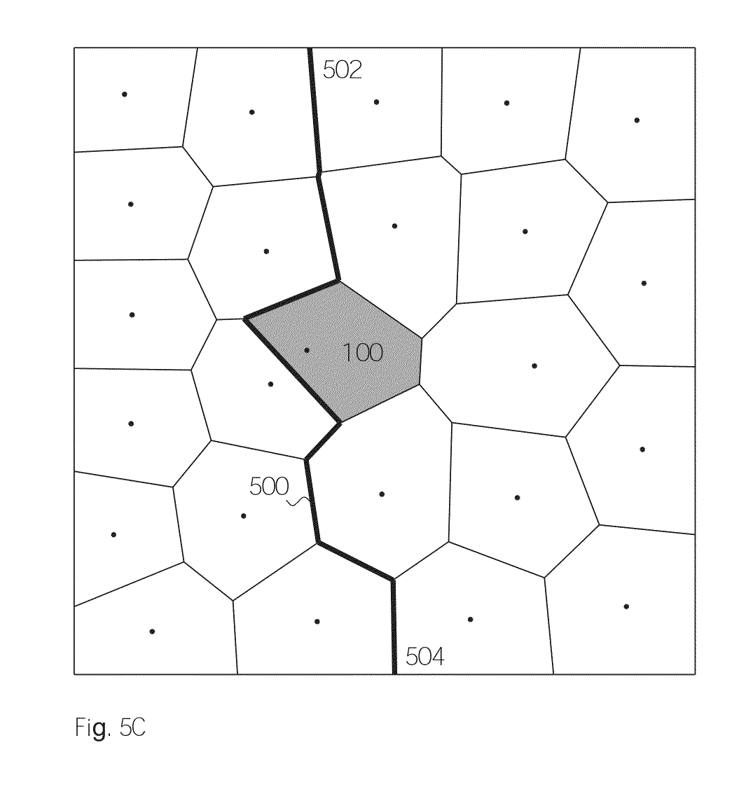

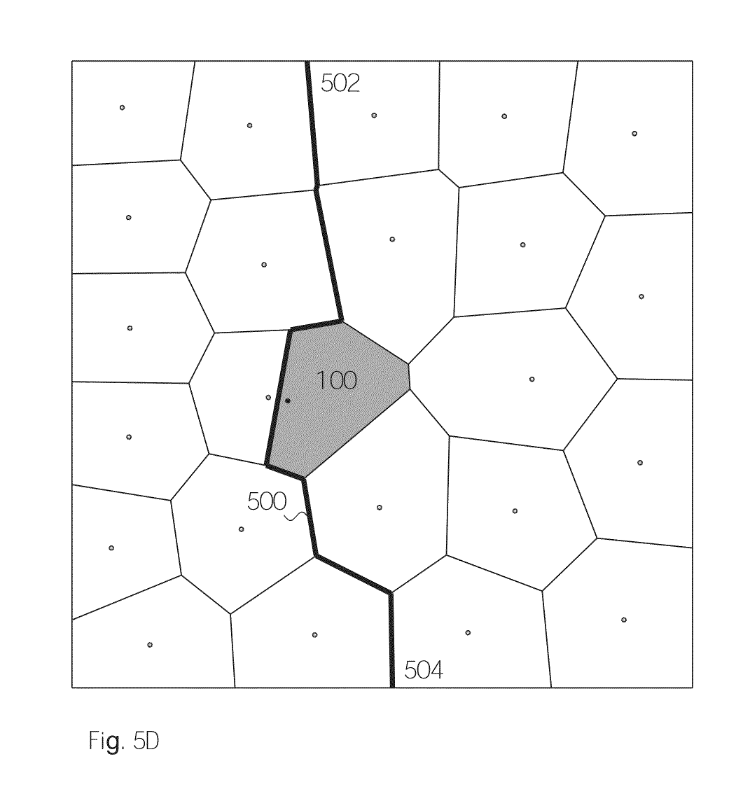

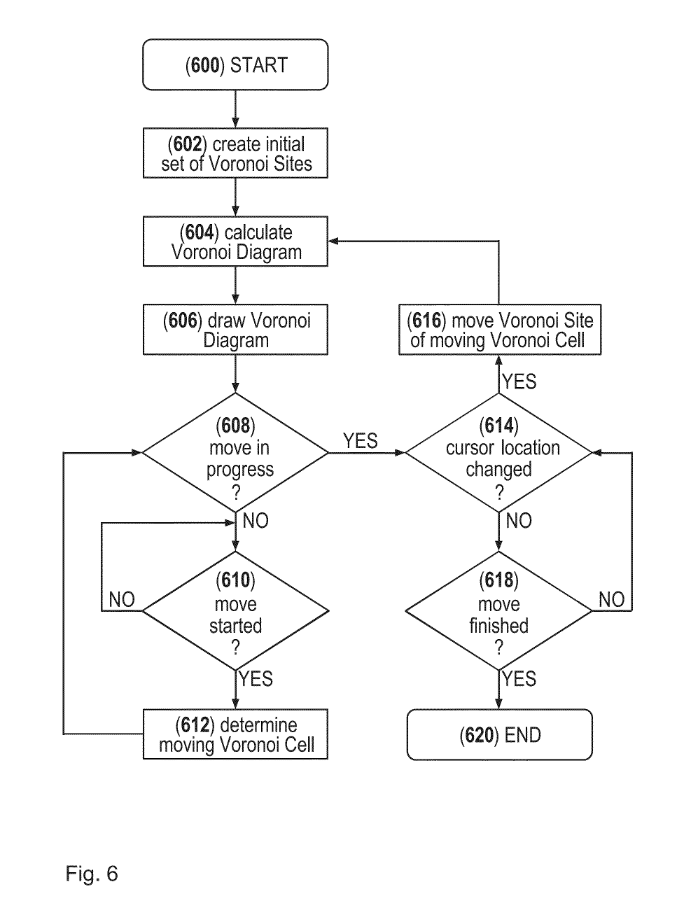

FIG. 5 depicts one of the alternate embodiments of the present invention. Observed space is decomposed using the Voronoi Diagram. A path 500 running from a point 502 to a point 504 is of special interest. The path exactly follows the edges of the Voronoi Cells. As the user moves the Voronoi Site 101 of the Voronoi Cell 100, the Voronoi Diagram is recalculated and redrawn. The path 500 is changed accordingly, and follows the new arrangement of the Voronoi Cells and their edges. The path 500 running from the point 502 to the point 504, formed by the edges of the Voronoi Cells of the Voronoi Diagram, may be used for various games or other application mechanics (e.g. the path of the computer-controlled entities).

### (14) Fourteenth Example

In one alternate embodiment, the Voronoi Sites within Voronoi Cells may be not be drawn on the screen and thus remain hidden to the user. The user may still move the position of a hidden Voronoi Site (and thus the visible Voronoi Cell).

### (15) Fifteenth Example

In one embodiment, the removal of the Voronoi Cells and the addition of the new Voronoi Cells are animated. In the case of the removal of the Voronoi Cells, their Voronoi Sites are sequentially moved off the screen, while recalculating and redrawing the Voronoi Diagram a few frames per second. This gives the animated impression of the Voronoi Cells departing the game space. In the case of the addition of the new Voronoi Cells, their Voronoi Sites are generated on the coordinates outside the game screen boundary and moved into their final positions, while recalculating and redrawing the Voronoi Diagram a few frames per second. This gives the animated impression of the Voronoi Cells arriving in the game space.

### (16) Sixteenth Example

In one embodiment, the visual markers may forecast the arrival of the new Voronoi Cells in the next move. One such a visual marker shows the position of the Voronoi Site of one incoming Voronoi Cell, which will appear after the user makes the move. The visual markers may be in a shape of a small diamond, square, circle, or any other shape. The visual markers may have the same distinctive property as the corresponding incoming Voronoi Cell. For example, if the distinctive property of Voronoi Cells is color, the visual marker may be of the same color as the incoming Voronoi Cell, which it forecasts.

### (17) Seventeenth Example

In this embodiment, a universal method for user manipulation of Voronoi Diagram based user interface elements is disclosed. This embodiment consists of a process of a single movement of a Voronoi Cell.

FIG. 4 is the flowchart of this embodiment. After the process is started (step 600), an initial set of Voronoi Sites is created (step 602). Using the initial set of Voronoi Sites, the Voronoi Diagram is calculated (step 604) and drawn (step 606).

In this embodiment, the Voronoi Diagram is calculated using Fortune's algorithm, which is well known to those skilled in computer art, but other existing methods for calculating the Voronoi Diagrams can also be used.

If there is no move in progress (step 608), the system waits for a move to be started (step 610). After the user initiates the move using the input device 302, the moving Voronoi Cell 100 is determined (step 612) as the Voronoi Cell which contains the (x, y) point which the user points to. This is the user-controlled Voronoi Cell 100 (FIG. 1A).

When the move is in progress (step 608), the system observes if the cursor location (x, y) changes (step 614) by the user's interaction with the input device 302. If the cursor location is changed (Δx, Δy), the Voronoi Site 101 of the moving Voronoi Cell 100 is moved accordingly (Δx, Δy) (step 616), and then the Voronoi Diagram is recalculated (step 604) and redrawn (step 606). The finished move (step 618) leads to the end of this process (620).

The process of the user's interaction with the user interface, as described in this embodiment, may serve various tasks in various applications, such as, but not limited to, entertaining games, educational games, educational applications, photo-related applications, and other applications where arrangement of the elements play a crucial role in the application.

With regard to the above descriptions, reference is made to embodiments of the present invention. However, it should be understood that the present invention is not limited to specific described embodiments. Instead, any combination of the following features and elements, whether related to different embodiments or not, is contemplated to implement and practice the present invention. Thus, the following aspects, features, embodiments and advantages are merely illustrative and are not considered elements or limitations of the appended claims except where explicitly recited in a claim(s). Likewise, reference to “the invention” or “present invention” shall not be construed as a generalization of any inventive subject matter disclosed herein and shall not be considered to be an element of limitation of the appended claims except where explicitly recited in a claim(s).

The flowcharts and other diagrams in the Figures illustrate the architecture, functionality, and operation of possible implementations of systems, methods, apparatuses, and computer program products according to various embodiments.

### GLOSSARY

Voronoi Site—a point in N-dimensional space (e.g., 2D, 3D, etc.), which serves as a generating point for the Voronoi Diagram.

Voronoi Diagram—a special kind of decomposition of a given space, determined by the distances to a specified set of generating points (Voronoi Sites) in space. In the case of 2D space, the space is partitioned into polygons (Voronoi Cells). Each polygon (Voronoi Cell) contains exactly one generating point (Voronoi Site) and every point in a given polygon is closer to the generating point of that polygon, than to any other generating point.

Voronoi Cell—a polygon, which contains a generating point (Voronoi Site) and is limited by other neighboring Voronoi Cells. The edges of the polygon are defined as sets of equidistant points between Voronoi Sites of the adjacent Voronoi Cells.

### DRAWINGS

### Reference Numerals

100: user-controlled Voronoi Cell;
101: Voronoi Site of user-controlled Voronoi Cell;
102A: Voronoi Cell currently adjacent to user-controlled Voronoi Cell;
102B: Voronoi Cell currently adjacent to user-controlled Voronoi Cell;
102C: Voronoi Cell currently adjacent to user-controlled Voronoi Cell;
102D: Voronoi Cell currently adjacent to user-controlled Voronoi Cell;
102E: Voronoi Cell currently adjacent to user-controlled Voronoi Cell;
102F: Voronoi Cell currently adjacent to user-controlled Voronoi Cell;
102G: Voronoi Cell currently adjacent to user-controlled Voronoi Cell;
102H: Voronoi Cell currently adjacent to user-controlled Voronoi Cell;
1021: Voronoi Cell currently adjacent to user-controlled Voronoi Cell;
102J: Voronoi Cell currently adjacent to user-controlled Voronoi Cell;
102K: Voronoi Cell currently adjacent to user-controlled Voronoi Cell;
102L: Voronoi Cell currently adjacent to user-controlled Voronoi Cell;
104A: unaffected Voronoi Cell;
104B: unaffected Voronoi Cell;
104C: unaffected Voronoi Cell;
200A: Voronoi Cell with a specific distinctive property, forming a cluster;
200B: Voronoi Cell with a specific distinctive property, forming a cluster;
200C: Voronoi Cell with a specific distinctive property, forming a cluster;
202A: Voronoi Cell with a different distinctive property (compared to Voronoi Cell 200A);
202B: Voronoi Cell with a different distinctive property (compared to Voronoi Cell 200A);
202C: Voronoi Cell with a different distinctive property (compared to Voronoi Cell 200A);
300: system;
302: input device;
304: computer or mobile device;
306: game's user interface;
308: display or touch-screen;
310: game software;
312: memory (RAM);
314: microprocessor (CPU);
316: computer-readable storage;
318: network interface;
320: game server;
322: internet or other network;
400: Game is started;
402: Initial set of Voronoi Sites is created;
404: Voronoi Diagram is calculated;
406: Voronoi Diagram is drawn;
408: Is there a move in progress?;
410: Is there a move starting?;
412: Moving Voronoi Cell is determined;
414; Has the cursor location been changed?;
416; Voronoi Site of the moving Voronoi Cell is moved;
418: Has the move been finished?;
420: Has a cluster of same-property cells been formed?;
422; Cluster of Voronoi Cells of the same-property is removed;
424; Are there no more cells left?;
426: Game is successfully finished (victory);
428; Is the user out of moves?;
430: Game is unsuccessfully finished (fail);
432: New Voronoi Sites are added;
500: path of special interest;
502: beginning of path of special interest;
504: end of path of special interest;
600: Process started;
602: Initial set of Voronoi Sites is created;
604: Voronoi Diagram is calculated;
606: Voronoi Diagram is drawn;
608: Is there a move in progress?;
610: Is there a move starting?;
612: Moving Voronoi Cell is determined;
614: Has the cursor location been changed?;
616: Voronoi Site of the moving Voronoi Cell is moved;
618: Has the move been finished?; and
620: Process finished.

What is claimed is:

1. A method for playing a video game by a user, said method comprising the steps of:
creating an initial set of Voronoi Sites,
wherein said Voronoi Sites are positioned at predetermined positions across a screen of the video game;
calculating a Voronoi Diagram using said initial set of said Voronoi Sites, resulting in a set of Voronoi Cells;
drawing a Voronoi Diagram using said initial set of said Voronoi Sites and said set of Voronoi Cells;
moving a Voronoi Site of a moving Voronoi Cell by the user initiating the move using an input device,
wherein said moving Voronoi Cell is determined as said Voronoi Cell which contains an (x, y) point which the user points to,
wherein when the move is in progress, a system observes if a cursor location (x, y) changes by the user's interaction with the input device, and
wherein if the cursor location is changed (Δx, Δy), said Voronoi Site of said moving Voronoi Cell is moved accordingly (Δx, Δy);
re-calculating a further Voronoi Diagram after each move;
re-drawing a further Voronoi Diagram after each move;
moving a Voronoi Site of a further moving Voronoi Cell until said further moving Voronoi Cell becomes adjacent to at least one Voronoi Cell of a cluster of Voronoi Cells having the same property; and
removing all of said Voronoi Cells of said cluster from said Voronoi Diagram when said further moved Voronoi Cell participates in a cluster of said Voronoi Cells with the required minimal number of Voronoi Cells of the same property.

2. The method for playing a video game by a user according to claim 1, wherein the step of removing all of said Voronoi Cells is done within a limited number of moves or a limited amount of time.

3. A method for manipulating Voronoi Diagram based user interface elements of a computer application by a user, said method comprising the steps of:
creating an initial set of Voronoi Sites,
wherein said Voronoi Sites are positioned at predetermined positions across a screen of the computer application;
calculating a Voronoi Diagram using said initial set of said Voronoi Sites, resulting in a set of Voronoi Cells;
drawing a Voronoi Diagram using said initial set of said Voronoi Sites and said set of Voronoi Cells;
moving a Voronoi Site of a moving Voronoi Cell by the user initiating the move using an input device,
wherein said moving Voronoi Cell is determined as said Voronoi Cell which contains an (x, y) point which the user points to,
wherein when the move is in progress, a system observes if a cursor location (x, y) changes by the user's interaction with the input device, and
wherein if the cursor location is changed (Δx, Δy), said Voronoi Site of said moving Voronoi Cell is moved accordingly (Δx, Δy);
re-calculating a further Voronoi Diagram after each move; and
re-drawing a further Voronoi Diagram after each move;
